(19) United States
(12) Patent Application Publication
(10) Pub. No.: US 2004/0223199 A1
(43) Pub. Date: Nov. 11, 2004

(54) Holographic single axis illumination for multi-axis imaging system

(76) Inventor: Artur G. Olszak, Tucson, AZ (US)

Correspondence Address: BIRDWELL, JANKE & DURANDO, PLC, 1100 SW SIXTH AVENUE, SUITE 1400, PORTLAND, OR, 97204, US

(21) Appl. No.: 10/430,956

(22) Filed: May 6, 2003

(51) Int. Cl. G02B 5/32

(52) U.S. Cl. 359/15; 359/1

(57) ABSTRACT

A single-axis illumination system for a multiple-axis imaging system, particularly an array microscope. A single-axis illumination system is used to trans-illuminate an object viewed with an array of imaging elements having multiple respective axes. The numerical apertures of the imaging elements are preferably matched to the numerical aperture of the illumination system. For Kohler illumination, the light source is placed effectively at the front focal plane of the illumination system. For critical illumination, the light source is effectively imaged onto the object plane of the imaging system. The light from a single axis source is separated by a holographic element into fields of view corresponding to respective imaging elements of the array microscope so as to match the numerical aperture thereof.

This invention relates to trans-illumination for imaging systems, particularly to a holographic single axis trans-illumination system for a multi-axis imaging system, and more particularly for a microscope array comprising a plurality of optical imaging elements having respective optical axes.

### BACKGROUND OF THE INVENTION

In imaging systems, particularly microscopy, adequate and appropriate illumination of the object to be imaged is essential. There must be enough light provided to the object or specimen to be viewed to permit the viewer to discern features of the object. In addition, the manner in which the light is provided to the object makes a difference in what features can be detected and the contrast with which they are imaged.

An ordinary microscope typically employs a compound imaging lens system for imaging the object. Any number of lenses or other optical elements such as polarizers, collimators, spreading optics, mirrors, and splitters may be included in the lens system. The lens system may be characterized in part by its numerical aperture, which essentially defines the limiting angle at which light from the object can pass into the lens system.

The object to be imaged by a microscope is typically located at the object plane by being placed on a substrate that is, in turn, positioned on a stage of the microscope that can be moved laterally with respect to the optical axis of the lens system. The stage may be motorized so that this movement may be automated or controlled by a computer. Moreover, the image plane may be provided with a camera or other imaging device for recording the image, or for monitoring the image under the same computer control.

In addition to being characterized by its numerical aperture, an imaging lens system is also characterized by its field of view. The field of view in visible light microscopes typically ranges from tens of microns to a few millimeters. This means that a macroscopically sized object of, for example, 20 mm×50 mm requires many movements of the stage for imaging the entire object. The stage manipulation and the consequent time required to image an object under high magnification is particularly troublesome in pathology analysis since the diagnostic information in the tissue may be located in only a small portion of the object that is being imaged.

A recent innovation in the field of light microscopy that addresses this problem is a miniaturized microscope array (“MMA”) which, when applied to a common object, is also referred to as an “array microscope.” In miniaturized microscope arrays, a plurality of imaging lens systems are provided having respective optical axes that are spaced apart from one another. Each imaging lens system images a respective portion of the object.

In an array microscope, a linear array is preferably provided for imaging across a first dimension of the object, and the object is translated past the fields of view of the individual imaging elements in the array, so that the array is caused to scan the object across a second dimension to image the entire object. The relatively large individual imaging elements of the imaging array are staggered in the direction of scanning so that their relatively small fields of view are contiguous over the first dimension. The provision of the linear detector arrays eliminates the requirement for mechanical scanning along the first dimension, providing a highly advantageous increase in imaging speed.

As mentioned, microscopy depends on having an adequate source of light to illuminate the object. If the object to be imaged is not opaque, it can be illuminated by light transmitted through the object. This type of illumination is known as “dia-illumination,” “through illumination,” or, as referred to herein, “trans-illumination.” An otherwise opaque object can be made to be light transmissive by cutting it into thin sections, or the object may be formed of transparent or partially transparent materials, such as biological materials. For example, pathologists routinely view tissue specimens and liquid specimens such as urine and blood using trans-illumination in a light microscope.

Trans-illumination typically makes use of an illumination lens system that projects light from a light source through the aforementioned substrate, through the object, and into the imaging lens system. The substrate is typically a glass or other transparent material slide, about 1 to 1.5 mm thick. The object to be viewed is mounted to or disposed on a front side of the substrate and light is applied to the object through the back side of the substrate. Since it is also formed of optical elements, the illumination lens system is governed by the same optical principles as the imaging lens system. Thence, the illumination lens system is likewise characterized by its numerical aperture and its field of view.

The MMA concept invites the corresponding concept of providing each imaging element with a corresponding illumination element. For optimal effect, the numerical aperture of illumination lens systems need to be matched to the numerical aperture of their corresponding imaging elements. That is, if the illumination system transmits light to the object at angles greater than the acceptance angle of the imaging system, some of the light may be wasted, which reduces system efficiency. On the other hand, if the illumination system transmits light over a narrower angular range, that is, one that does not extend to the acceptance angle, the imaging system cannot take full advantage of its resolving power.

In a high numerical aperture array microscope it is desirable to pack the imaging elements of the array close together so as to acquire image data for contiguous parts of the object in the minimum scan time. On the other hand, a trans-illumination system places a limit on how close the corresponding illumination lens systems can be packed and still provide the desired matching of numerical apertures. This is because the object must be supported by a slide or other transparent member that must be sufficiently thick to provide mechanical stability. Where the illumination system must project light through a glass substrate 1 to 1.5 mm thick, the working distance cannot be greater than that amount. To have a sufficiently long illumination system working distance, while maintaining the same numerical aperture as the imaging system, the diameter of the lens of the illumination system must be larger than the diameter of the lens of the imaging element. This means that providing each imaging element with its own illumination element requires either that suboptimal imaging element packing or suboptimal numerical aperture matching must be employed.

Accordingly, there is an unfulfilled need for devices and methods for providing trans-illumination for arrays of imaging elements having respective optical axes, particularly array microscopes, without sacrificing either image element packing density or optimal numerical aperture matching.

### SUMMARY OF THE INVENTION

The present invention meets the aforementioned need by providing, in a multi-axis imaging system such as an array microscope, a single axis trans-illumination system that permits maximum packing of the imaging elements and optimum matching of the numerical aperture of the illumination system with the numerical aperture of the imaging elements while providing a practical working distance for the illumination system. Thus, a single optical system employing a holographic element is provided for illumination, preferably having the same numerical aperture as the individual imaging elements. By means of a holographic element, the otherwise continuous illumination field of view can be split in a multitude of individual fields of view that match in shape and numerical aperture the requirements of the array microscope. This arrangement can be used to provide either Kohler illumination, where the light source is imaged into the pupils of the arrayed elements of the imaging system, or critical illumination, where the light source is imaged to the object plane of the imaging system.

To produce a desired illumination radiance distribution, a holographic or diffractive element or elements may be used with an essentially coherent light source, such as a laser; an incoherent quasi-monochromatic source, such as an array of light-emitting diodes; or even a broad-band light source. In the case of an essentially coherent light source, and an incoherent, quasi-monochromatic light source, a thin holographic element is used. Such an element can be an amplitude or a phase hologram, or an element having both amplitude and phase hologram characteristics. The holographic element may be produced using any conventional holographic technique, though computer generation is a particularly suitable method. Refractive and diffractive elements, such as a collimation lens system positioned before or after a holographic element, may be combined with the holographic element to achieve the desired illumination pattern. Typically, thin holograms are used with quasi-monochromatic light sources. In the case of a light source having a relatively broad frequency spectrum, a thick (volume) holographic element is used.

The objects, features and advantages of the invention will be more readily understood upon consideration of the following detailed description of the invention, taken in conjunction with the accompanying drawings.

### BRIEF DESCRIPTION OF THE DRAWINGS

FIG. 1 is a perspective view of a first exemplary microscope array with which the present invention may be used.

FIG. 2 is a perspective view of a second exemplary microscope array with which the present invention may be used.

FIG. 3 is a ray trace diagram for an imaging element of the microscope array of either FIGS. 1 or 2.

FIG. 4 is a ray trace diagram for a Kohler illumination system for use with a microscope array.

FIG. 5 is a ray trace diagram for a critical illumination system for use with an array microscope.

FIG. 6a is schematic illustration of the use of a thin hologram with a coherent light source to provide critical illumination to the elements of a microscope array while substantially matching the angular distribution of illumination light to the numerical aperture of the microscope array elements.

FIG. 6b is schematic illustration of the use of a thin hologram with a coherent light source to provide Kohler illumination to the elements of a microscope array while substantially matching the angular distribution of illumination light to the numerical aperture of the microscope array elements.

FIG. 7e is an illustration of the physical concept of how a hologram for the arrangement of FIGS. 6a and 6b can be generated.

FIG. 8 is a schematic illustration of a system using a thin hologram with a coherent light source for illumination of a plurality of elements of a microscope array while matching the angular distribution of illumination light to the numerical aperture of the microscope array elements.

FIG. 9 is a schematic diagram of a system using a thin hologram with a quasi-monochromatic, spatially incoherent light source for illumination of elements of a microscope array while matching the angular distribution of illumination light to the numerical aperture of the microscope array elements.

FIG. 10 is a schematic diagram of the physical concept for using a thick hologram to illuminate a microscope array element with a broad-band light source while substantially matching the angular distribution of illumination light to the numerical aperture of the array element.

FIG. 11a is a schematic diagram of a preferred embodiment of a system according to the present invention employing a thin hologram to provide critical illumination for a plurality of microscope array elements using a quasi-monochromatic, spatially coherent light source.

FIG. 11b is a schematic diagram of a preferred embodiment of a system according to the present invention employing a thin hologram to provide Kohler illumination for a plurality of microscope array elements using a quasi-monochromatic spatially coherent light source.

FIG. 12 is a detailed schematic diagram of telecentric Kohler illumination produced by means of a holographic element.

FIG. 13 is a schematic diagram of an alternative embodiment of a system according to the invention wherein a refractive element is used with a holographic element to reduce the deviation required of the holographic element.

FIG. 14 is a ray trace diagram showing the influence of field curvature on critical illumination uniformity in a microscope system.

FIG. 15 is a schematic diagram of a Kohler illumination system using a diffraction grating element to produce an array of illumination spots.

### DETAILED DESCRIPTION OF THE INVENTION

The illumination systems and methods of the present invention are adapted for use with multi-axis imaging systems, particularly microscope arrays, and more particularly array microscopes. Array microscopes, which are a recent development, may be used, for example, to scan and image entire tissue or fluid samples for use by pathologists. Individual imaging elements of array microscopes are closely packed and have a high numerical aperture. This enables the capture of high-resolution microscopic images of the entire sample in a short period of time by scanning the specimen with the array. It also presents novel illumination challenges which are met by the present invention.

1. Microscope Arrays

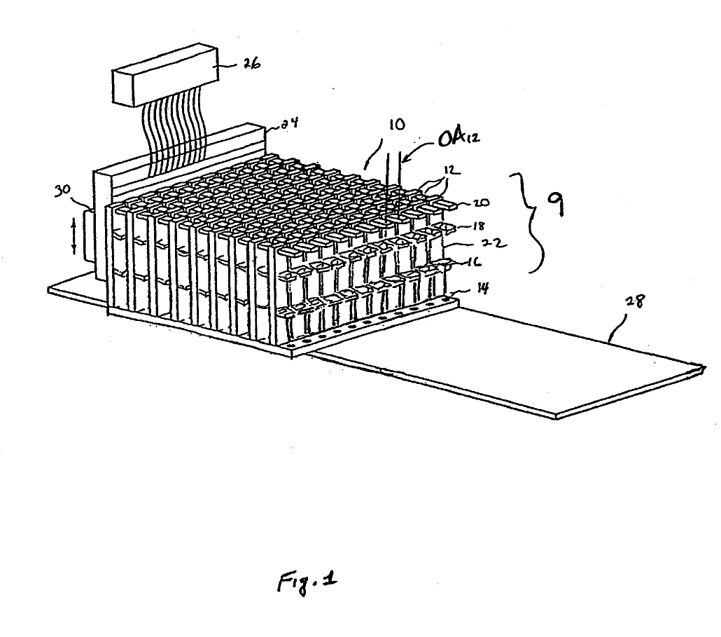

An exemplary microscope array 10 is shown in FIG. 1. The microscope array 10 comprises an imaging lens system 9 having a plurality of individual imaging elements 12. Each imaging element 12 may comprise a number of optical elements, such as the elements 14, 16, 18 and 20. In this example, the elements 14, 16 and 18 are lenses and the element 20 is a detector, such as a CCD array. More or fewer optical elements may be employed. The optical elements are typically mounted on a vertical support 22 so that each imaging element 12 defines an optical imaging axis OA₁₂ for that imaging element.

The microscope array 10 is typically provided with a detector interface 24 for connecting the microscope to a data processor or computer 26 which stores the image data produced by the detectors 20 of the imaging elements 12. An object is placed on a stage or carriage 28 which may be moved beneath the microscope array so as to be scanned by the array. The array would typically be equipped with an actuator 30 for moving the imaging elements axially to achieve focus. The microscope array 10 would also include an illumination lens system, as explained hereafter.

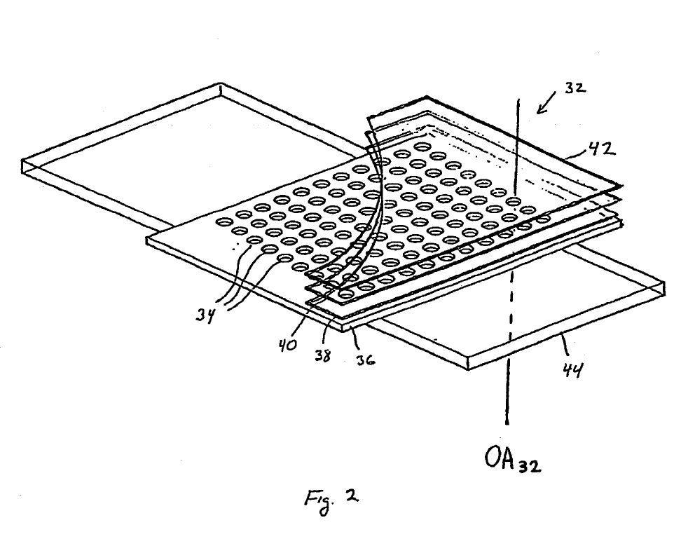

Another embodiment of a microscope array 32 is shown in FIG. 2. In the imaging lens system, a plurality of lenses 34 corresponding to individual imaging elements are disposed on respective lens plates 36, 38 and 40, which are stacked along respective optical axes OA₃₂ of the imaging elements. Detectors 42 are disposed above the lens plate 40. As in the case of the microscope array 10, the microscope array 32 may be employed to scan a sample on a carriage 44 as the carriage is moved with respect to the array or vice versa.

Microscope arrays wherein the imaging elements are arranged to image respective contiguous portions of a common object in one dimension while scanning the object line-by-line in the other dimension are also known as an array microscope. Array microscopes may be used, for example, to scan and image entire tissue or fluid samples for use by pathologists. Individual imaging elements of array microscopes are closely packed and have a high numerical aperture, which enables the capture of high-resolution microscopic images of the entire specimen in a short period of time by scanning the specimen with the array microscope.

The detectors of array microscopes preferably are linear arrays of detector elements distributed in a direction perpendicular to the scan direction. As the imaging elements produce respective images that are magnified, each successive row of elements is offset in the direction perpendicular to the scan direction. This permits each imaging element to have a field of view that is contiguous with the fields of view of other appropriately positioned optical systems such that collectively they cover the entire width of the scanned object. The present invention is particularly suited for array microscopes; however, the present invention may be employed in other types of microscope arrays and multi-axis imaging systems having a plurality of elements for imaging respective locations in space.

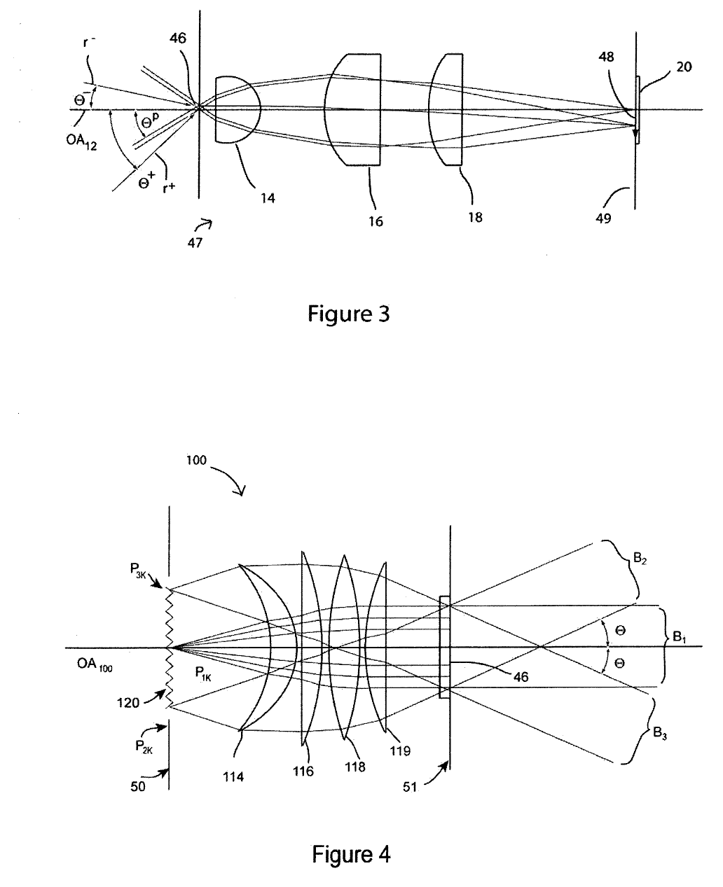

FIG. 3 is a ray trace diagram for an exemplary imaging element of the microscope arrays depicted in FIGS. 1 and 2. Each imaging element defines an object plane 47 and an image plane 49. An object 46 to be imaged is disposed on the object plane 47, and the detector 20 is disposed on the image plane 49. An illumination system (not shown in FIGS. 1 and 2) trans-illuminates the object 46. A first lens 14 collects light from a portion of the object 46, and the light propagates through lenses 16 and 18 to form an image 48 on the detector 20. The imaging elements are supported by the support 22 so that, preferably, the object and image planes of the multiple imaging elements 12 of the microscope array 10 (not shown in FIG. 3) combine to form a single coplanar object plane 47 and a single coplanar image plane 49 for the entire array.

Each imaging element 12, regardless of its complexity, establishes an acceptance angle Θₚ with respect to its optical axis. Rays of light incident on the object plane at angles Θ⁺ greater than the acceptance angle Θₚ will not, unless scattered by the object 46, contribute to the image 48. Conversely, if all of the rays of light incident on the object plane 47 are at angles Θ⁻ less than the acceptance angle Θₚ, the object will be under-illuminated. Ideally, rays of illumination light should be incident on the face of the object at all angles less than or equal to the acceptance angle Θₚ. That is, the numerical aperture of the illumination system should match the numerical aperture of the imaging element.

2. Kohler Illumination

An exemplary single-axis Kohler illumination lens system 100 using refractive optical elements is shown in FIG. 4. The illumination lens system may comprise a number of optical elements, such as the elements 114, 116, 118 and 119, and a light source 120. In this example, the elements 114, 116, 118 and 119 are lenses and the light source 120 may be any source of sufficient intensity, though a significantly extended source is preferred. More or fewer optical elements may be employed. For example, FIG. 4(b) shows an alternative illumination lens system 101, having three lens elements 113, 115 and 117. Any number of illumination lens system designs may be used, depending on the designer's goal. The optical elements of the illumination lens system are typically mounted on a support (not shown) or are part of a plate assembly as shown in FIG. 2 so as to be distributed along a single illumination optical axis OA₁₀₀ parallel to the optical axes of the imaging system. The light source is centered on the illumination system optical axis OA₁₀₀, at the front focal plane 50 of the illumination lens system, and the illumination lens system is disposed with respect to the imaging elements such that the image plane of the illumination system is placed at the entrance pupil of the imaging elements, or at a plane conjugate thereto.

For purposes of illustration of the principles of Kohler illumination, in FIG. 4(a) three points P₁ₖ, P₂ₖ, and P₃ₖ on the source 120 are shown. The point P₁ₖ is on the optical axis, and points P₂ₖ and P₃ₖ are symmetrically positioned about the illumination system optical axis at extreme ends of the source. Some of the light radiated from the point P₁ₖ enters the lens 114, is transmitted through the lenses 116, 118 and 119, and leaves the lens 119 as a collimated beam of light B₁. The light beam B₁ is parallel to the optical axis OA₁₀₀. Similarly, some of the light radiated from the point P₂ₖ enters the lens 114, is transmitted through the lenses 116, 118 and 119, and leaves the lens 119 as a collimated beam of light B₂, and some of the light radiated from the point P₃ₖ enters the lens 114 and leaves the lens 119 as a collimated beam of light B₃. The light beams B₂ and B₃ are incident on the object plane 51 of the imaging elements at respective illumination angles Θ with respect to the illumination optical axis OA₁₀₀. It will be appreciated that, since P₂ₖ and P₃ₖ represent points on the source at the extreme ends, and point P₁ₖ represents a point on the source that is centrally disposed therebetween, the lens system 100 will produce similar collimated beams for points between the points P₂ₖ and P₃ₖ having angles varying between +/−Θ. Any light that is incident on the object plane 51 at an angle greater than the illumination angle Θ corresponds to stray light and not light produced by the source 120.

Returning to FIG. 3, as mentioned previously, each imaging element 12 establishes an acceptance angle Θₚ with respect to the optical axis OA₁₂ of the imaging element. Rays of light r⁺ incident on the object plane at angles Θ⁺ greater than the acceptance angle Θₚ will be excluded by the imaging element 12, and rays of light r⁻ incident on the object plane 47 at angles Θ⁻ equal to or less than the acceptance angle Θₚ will pass into the imaging element and therefore contribute to the image produced thereby.

When the illumination lens system 100 is related to a single imaging element 12, it will be appreciated that the illumination angle Θ of the illumination lens system works in concert with the acceptance angle Θₚ of the imaging lens system 12 shown in FIG. 3. In particular, matching these angles avoids projecting light that is unnecessary for illuminating the object, which would occur if the illumination angle were greater than the acceptance angle, while at the same time provides all the light that is necessary to illuminate the object, which would not occur if the illumination angle were less than the acceptance angle.

3. Critical Illumination

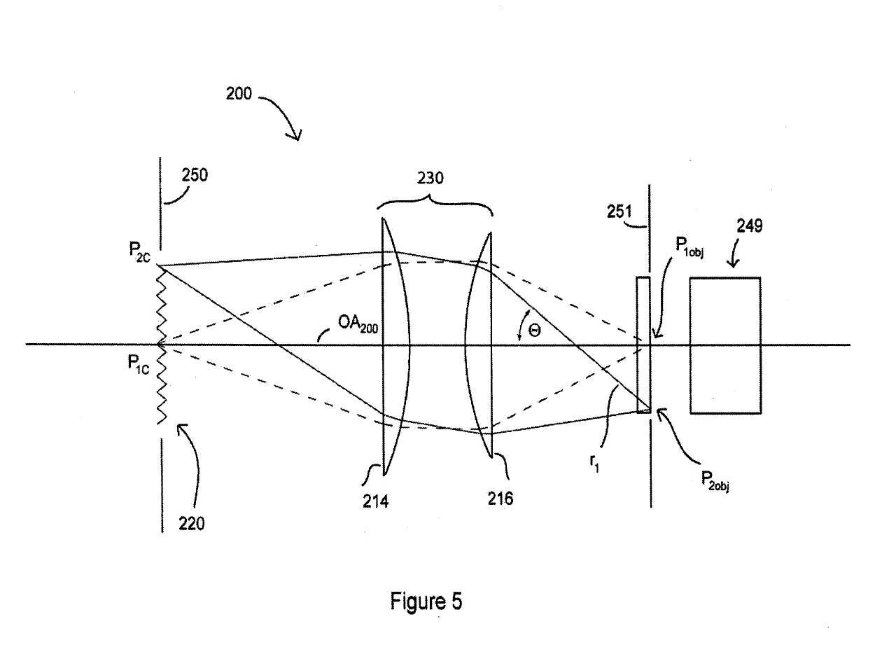

FIG. 5 shows an exemplary array microscope 249 employing, for example, either of the microscope arrays 10 and 32, having a critical illumination refractive lens system 230. The illumination lens system 230 may comprise a number of optical elements, such as the elements 214 and 216, and a light source 220. In this example, the elements 214 and 216 are lenses and the light source 220 is preferably an LED array; however, the light source may be any source that provides the desired spatial intensity distribution. More or fewer optical elements may be employed. It may also be useful to provide for spatially dependent wavelengths or “colors” by providing that different light emitting diodes in the array emit light at different wavelengths.

The optical elements of the illumination lens system are ordinarily mounted on a common support (not shown) along an illumination optical axis OA₂₀₀ parallel to the imaging system optical axes or are part of a plate assembly. The light source is placed on the illumination optical axis, at an object plane 250 of the illumination lens system. The corresponding image plane is shown at 251, which is also the object plane of the imaging system 249. Thus, the light source is imaged to the object plane of the imaging system.

For purposes of illustration of the principles of critical illumination, two points P_{1c} and P_{2c} on the source 220 are shown. Point P_{2c} is located at an extreme end of the source and point P_{1c} is centrally located on the optical axis of the illumination system. As shown, all the light transmitted from the point P_{1c} that is collected by the lens 214 is mapped to the point P_{1obj} on the object plane 251. Similarly, all the light transmitted from the point P_{2c} that is collected by the lens 214 is mapped to the point P_{2obj}. It will now be appreciated that the lens system 230 maps the source onto the object plane, and adjusting the size and lateral position of the source can provide for precisely mapping the source onto an object at the object plane.

The ray r₁, from the point P_{2c}, defines a maximum illumination angle Θ with respect to the illumination optical axis OA₂₀₀ as it passes through and beyond the object plane 251. Considering that there is a symmetrically disposed ray (not shown) corresponding to another point on the source at its opposite extreme end, it will be appreciated that the maximum illumination angle for the system will be +/−Θ. Any light that is incident on the object plane 251 at an angle greater than the illumination angle Θ corresponds to stray light and not light produced by the source 220. As with Kohler illumination, it is highly desirable to match the illumination angle Θ of the illumination lens system with the acceptance angles Θₚ (FIG. 3) of each of the individual imaging elements in the imaging lens system 249. As long as the optical axes of the imaging elements are parallel, a single maximum illumination angle Θ can be made to match the pass angles Θₚ of all the imaging elements.

4. Holographic Structured Illumination

According to the present invention, a holographic or diffractive element in the optical path of the illumination elements is used to produce an intensity and irradiance pattern at the object using a coherent light source, such as a laser; an incoherent, quasi-monochromatic source, such as an array of light-emitting diodes; or even a broad-band source.

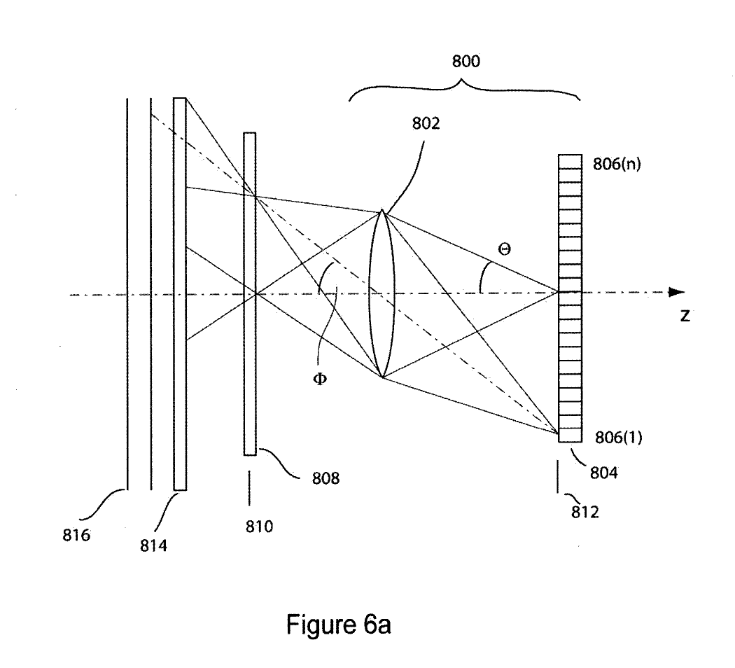

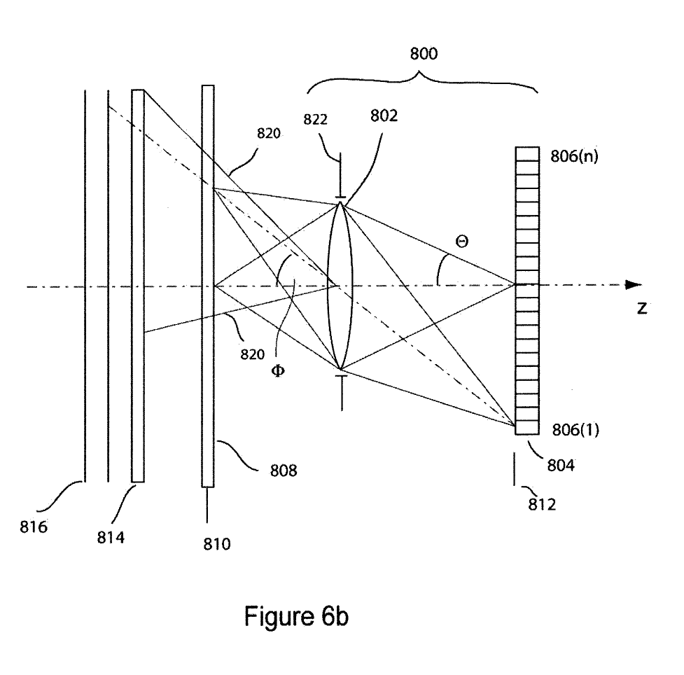

Referring to FIG. 6a, a representative microscope array element 800 comprises a lens 802 and a detector array 804, having a plurality of detectors 806(1)-806(n). The element has an object space numerical aperture, NA_{obj}=(sin Θ)xm, where m is the magnification of the element, and an angular field of view, FOV=Φ. The element is focused on an object 808 located at the object plane 810 of the element, thereby producing an image of the object at image plane 812 of the array element 800. A hologram 814 receives light 816 of a predetermined mean wavelength λ, and diffracts the beam to illuminate the object with a specific spatial distribution of irradiance and a numerical aperture substantially equal to the numerical aperture NA_{obj} of the array element. Such a holographic element can simultaneously ‘focus’ the incoming light beam into a number of areas corresponding to locations of fields of view of individual optical systems. The spatial uniformity of irradiance and the angular distribution of radiant intensity can be adjusted by taking into account both the phase and the amplitude distribution of the light beam illuminating the hologram. The embodiment of FIG. 6a is a version of a critical illumination, as explained above.

A Kohler illumination system employing a holographic element is shown in FIG. 6b. The difference with respect to the critical illumination system is that in the Kohler illumination system the image of the light source is projected into the entrance pupil 822, rather than the object plane, of the optical system.

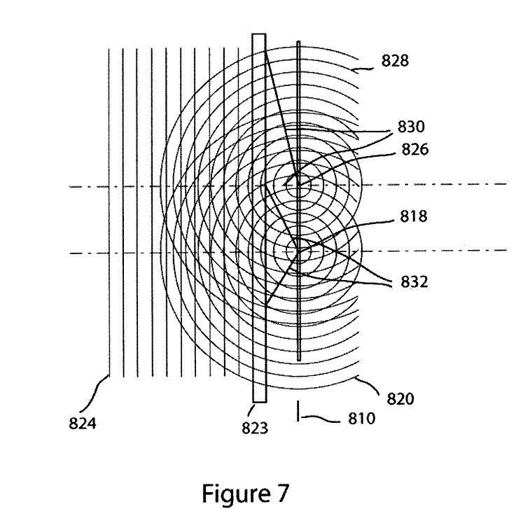

The generation of part of a hologram for focusing collimated, quasi-monochromatic light on an object to be viewed by the array element is illustrated by FIG. 7, for two points on the object within the field of view of the array element. In principle, point source 818, located in the object plane and on the optical axis of the array element, produces a spherical light wave 820 of wavelength λ, which interferes at plane 823 with a reference plane light wave 824 of wavelength λ, where the spherical and plane waves have a fixed phase relationship. The resulting interference pattern is recorded on a medium, such as film, located at plane 823, thereby producing a hologram. As is well understood in the art, when a plane wave thereafter illuminates the hologram, a real image of the point source will be reproduced, thereby focusing light to the same point from which the spherical wave was emitted. As is also well understood, for thin holograms a virtual image on the front side of the hologram will also be produced, but as practical matter this merely reduces the illumination efficiency by at least fifty percent.

Likewise, point source 826, located in the object plane of the array element, but offset to the edge of its field of view, produces a spherical wave 828 that also interferes with the plane wave 824, and the resulting interference pattern is also recorded on the medium as part of the hologram. In principle, an infinite number of such point sources in the object plane and within the field of view of the array element are used to produce the desired hologram, in accordance with the linear superposition principle. In practice, the hologram may be produced (1) using a finite number of point sources, (2) using the array element itself as source of reverse-propagating light, or (3) generating the hologram by a computer, as is commonly understood in the art. In the latter two cases, it is then straight forward to limit the interference pattern to that portion of the hologram that is within the field of view of the array element, as shown by lines 830 and 832, for example. Some known techniques for computer generation of holograms are described, for example, by Gmitro, Arthur F., Coleman, Christopher L., Multilevel phase holograms for free-space optical interconnects: design and analysis, Proc. SPIE Vol. CR62, p. 88-105, Optoelectronic Interconnects and Packaging, Ray T. Chen; Peter S. Guilfoyle; Eds., Publication Date 1/1996, hereby incorporated by reference in their entirety.

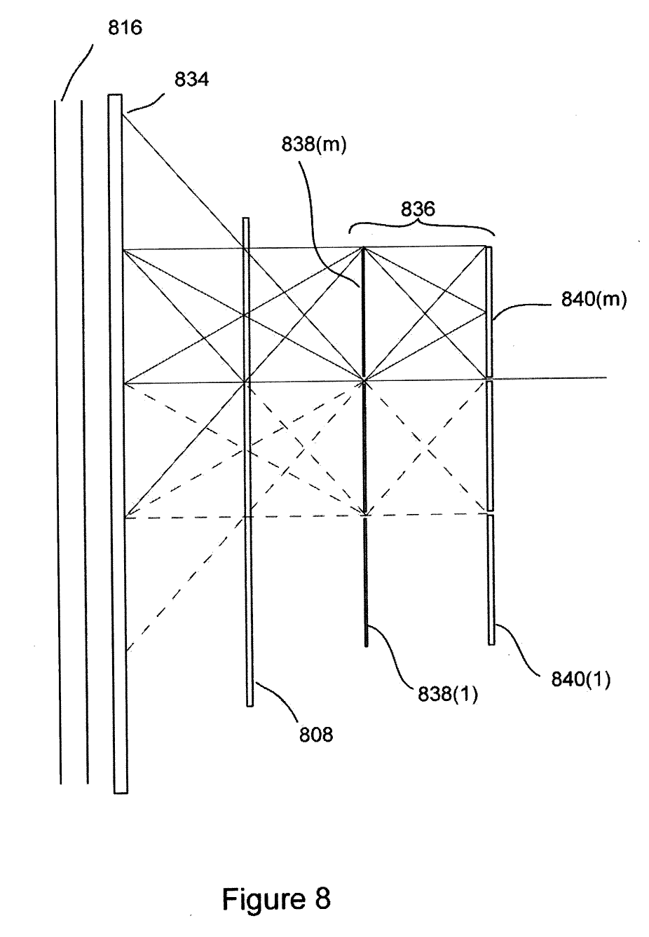

Turning to FIG. 8, in accordance with the superposition principle, a single hologram 834 may be constructed to focus light on a plurality of portions of the object 808 viewed by respective elements of an array of elements 836, having respective lenses 838(1)-838(m) and detector arrays 840(1)-840(m), while matching the angular distribution of the cones of light from the hologram to the object space numerical aperture NA_{obj} of each such element.

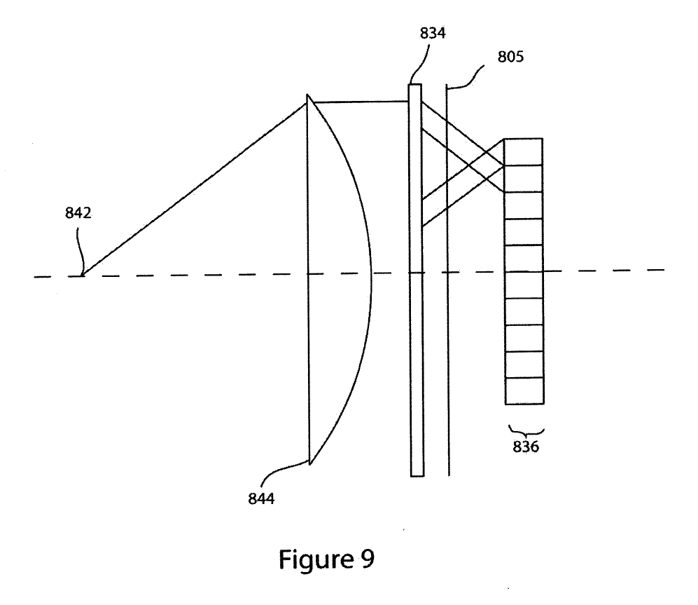

While the embodiments described with respect to FIGS. 6a, 6b and 8 are based on the use of a coherent light source, such as a collimated laser beam, such a source is not necessary for use of a hologram according to the invention. Adequate spatial coherence may, under some circumstances, be achieved by collimating the light from an incoherent “point” source, that is, by placing the point source 842 at the front focal plane of the illumination optics 844, as shown in FIG. 9.

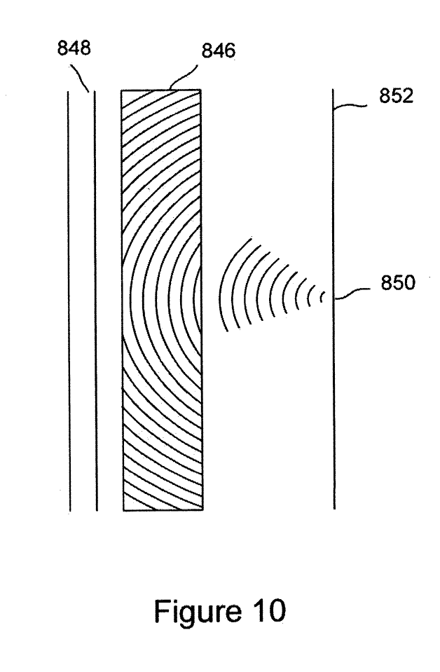

While the embodiments described with respect to FIGS. 6a, 6b, 8 and 9 are based on quasi-monochromatic light using a thin hologram, the invention is not limited thereto. As shown in FIG. 10, a thick hologram 846 can be used so that the light source may produce light having a relatively large power spectrum, such as, for example, white light. In this case, plane waves 848 having a broad frequency spectrum illuminate the thick hologram 846, which selectively focuses a narrow wavelength of light to a point 850 on the object plane 852.

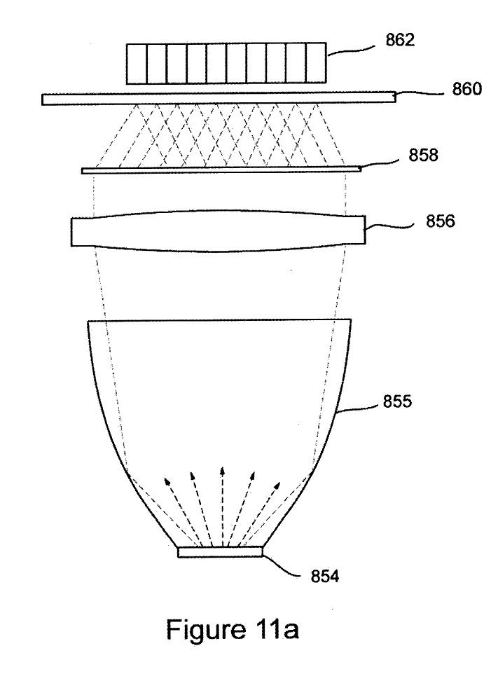

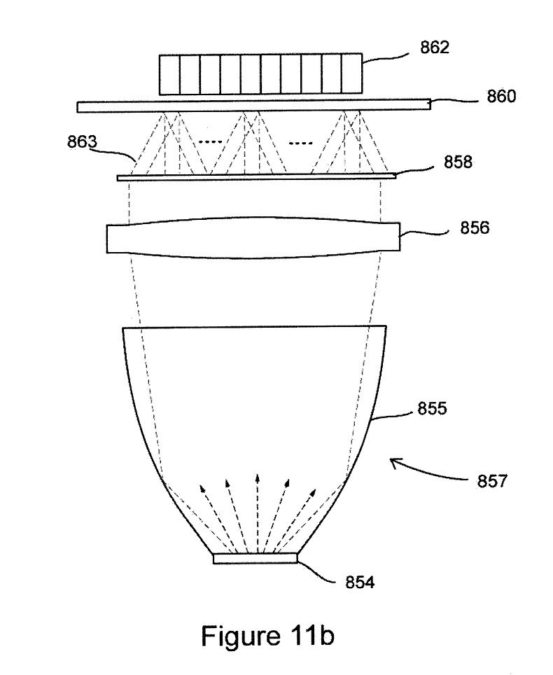

As is shown in the preferred embodiment of FIG. 11a, it has been found that adequate results in constructing a critical illumination system can ordinarily be achieved by using a light source comprising an array 854 of quasi-monochromatic light emitting diodes whose light is directed by a compound parabolic reflector (“CPC”) or other suitable optical element 855 toward a condenser 856, which together substantially collimate the light, and by using a hologram 858 that produces a structured light pattern that focuses light on the areas of the object 860 imaged by respective array elements 862 without matching the angular distribution of the cones of illumination light to the numerical apertures of the elements.

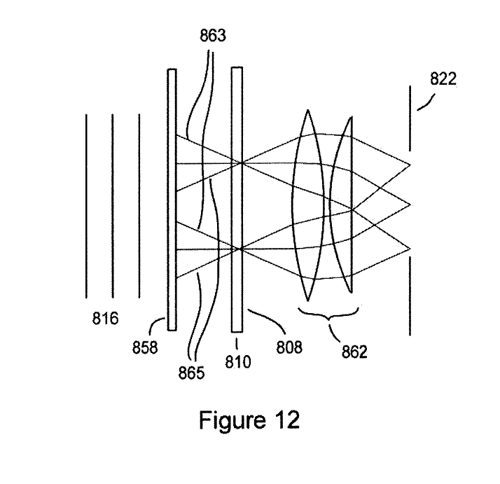

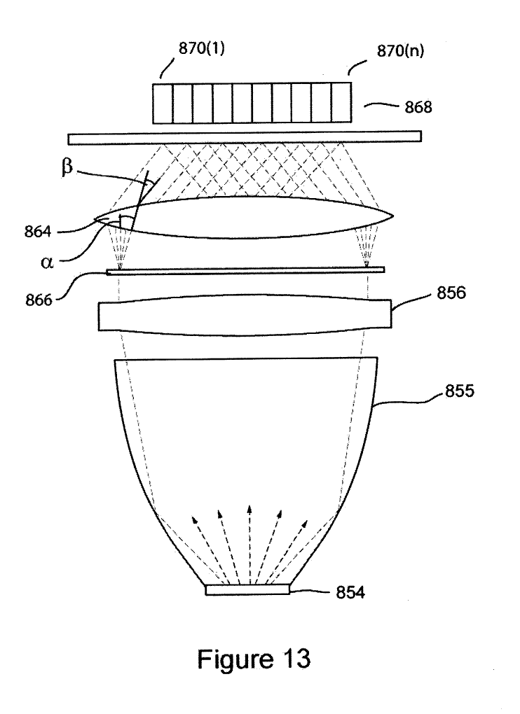

FIG. 11b shows a Kohler illumination system similar to the critical illumination system of FIG. 12a, except that images of the illumination light source 857 are projected into the entrance pupils of respective array elements 862. The holographic element 858 may produce rays 863 that converge at the entrance pupils or, in the case of a telecentric Kohler illumination system, are parallel to one another as shown in FIG. 13a and described further with respect to FIG. 13b, as follows. Most modem microscopic systems are designed according to principle of telecentricity in the object space. In a telecentric system the pupils are located at infinity so that the distance between points in the image does not change with defocus which is important for quantitative analysis of the acquired images.

A more detailed illustration of a telecentric Kohler illumination system is shown in FIG. 12 for a single array element. Holographic element 858 reshapes the incoming beam into bundles of parallel beams such as beams 863 and 865 at respective angles that illuminate the locations in the object plane that correspond to individual fields of view of the imaging array element 862, so that the bundles of rays are focused at the entrance pupil of the element 862. The numerical aperture of light beam bundles 863 matches the numerical aperture of the imaging array element.

In addition, as shown by an exemplary critical illumination system in FIG. 13, one or more supplemental refractive or diffractive optical elements can be placed between the holographic element and the plane of the object to help produce a more uniform spatial distribution of irradiance and angular distribution of radiant intensity, and to relax the minimum deviation angle that needs to be produced by the holographic element. In FIG. 13, a converging lens 864 is disposed between a holographic element 866 and the array 868 of optical elements 870(1)-(n). The holographic element 866 need only produce deviation angle α, while the converging lens 864 produces additional deviation angle β. As the deviation angle is related to density of diffraction lines of the holographic element that must be recorded in the medium, the use of such additional refractive elements reduces the medium density requirement for the holographic element. As shown by the embodiment of FIG. 13, the holographic element 866 can be made so as to produce a symmetric diffraction pattern, leaving the focusing at the various diffraction orders on respective optical elements to the lens 864. In addition, the holographic element itself 866 may be a hybrid element comprising one or more diffractive or holographic elements. One example of such structure is combination of two diffractive gratings with principal axes oriented at right angle.

The principle of operation of a hologram is diffraction of light due to a superposition of periodic structures representing an interference pattern. Such structures have inherent dispersion, which can cause lateral chromatic aberration. Consequently, the illumination properties of individual optical systems, such as the spatial irradiance distribution, may vary with wavelength. In some cases it is possible to limit the wavelength dependency of such an element by proper design of a hologram or the refractive part of the illumination system.

The hologram may be designed to be relatively wavelength insensitive using the techniques described in Curtis E. Volin, “Portable snapshot infrared imaging spectrometer,” PhD dissertation, Tucson, Ariz., University of Arizona, 2000, hereby incorporated by reference in its entirety. In accordance with those techniques, the hologram is generated by a computer. First, the desired illumination pattern in the far field of the hologram is chosen. Then, a trial hologram to produce that pattern is chosen and the far field amplitude pattern produced by that trial hologram is computed. For a plurality of wavelengths, the phase delay of the hologram pixels is then perturbed a selected amount and the light amplitude pattern in the far field is again computed. The changes in amplitude are also computed. A sensitivity matrix for the hologram is then derived by dividing the changes in amplitude by the phase perturbation, and the singular value decomposition (“SVD”) of that sensitivity matrix is found. Then, the differences in amplitude between the desired amplitude pattern and the amplitude pattern produced by the original trial hologram are computed for the plurality of wavelengths, and corresponding changes to the phase delays in the hologram are computed from those differences using the SVD of the sensitivity matrix. A new trial hologram is then produced by modifying the trial hologram to compensate for those phase delays. If the new far-field amplitude pattern is sufficiently close to the desired pattern, the process is complete. If not, it is repeated using each successive new trial hologram until the results are satisfactory, though it may not be necessary to compute a new sensitivity matrix each time, depending on the circumstances. It is to be recognized that other methods for creating a relatively wavelength insensitive hologram might also be used without departing form the principles of the invention.

In other cases, the chromatic aberration of holographic element can be diminished or eliminated by proper design of the optical system positioned before or after the element. For example, using specific combinations of optical materials such as crown and flint glass, plastics and other diffractive elements with appropriate distribution of power and relative distances may be used. Holographic elements can be assigned specific chromatic properties and, in order to reduce their influence, common engineering practices used in optical design can be followed For example, see “Lens Design Fundamentals” by Rudolph Kingslake, ISBN: 0124086500 Academic Press, 1978.

The versatility of holograms also allows reducing the influence of aberrations that may be present in the remaining part of the optical system, such as distortion or field curvature, by encoding into the holographic element appropriate amounts of aberrations with opposite signs to those corresponding aberrations introduced by the rest of the optical system. For example, if the refractive part of the illumination system has +3 waves of field curvature, that field curvature can be reduced by encoding −3 waves of field curvature into the holographic element, resulting in a flat field of view.

Another example of aberration correction using a holographic element is the correction of distortion, which is a result of the variation of lateral magnification of the image with the field of view. In an optical system having a significant amount of distortion, a rectangular grid of points is imaged into a distorted pin-cushion shape for positive distortion, and into a barrel shape for negative distortion. By altering the angles of propagation of beams corresponding to different fields of view emerging from the holographic element the influence of distortion can be minimized.

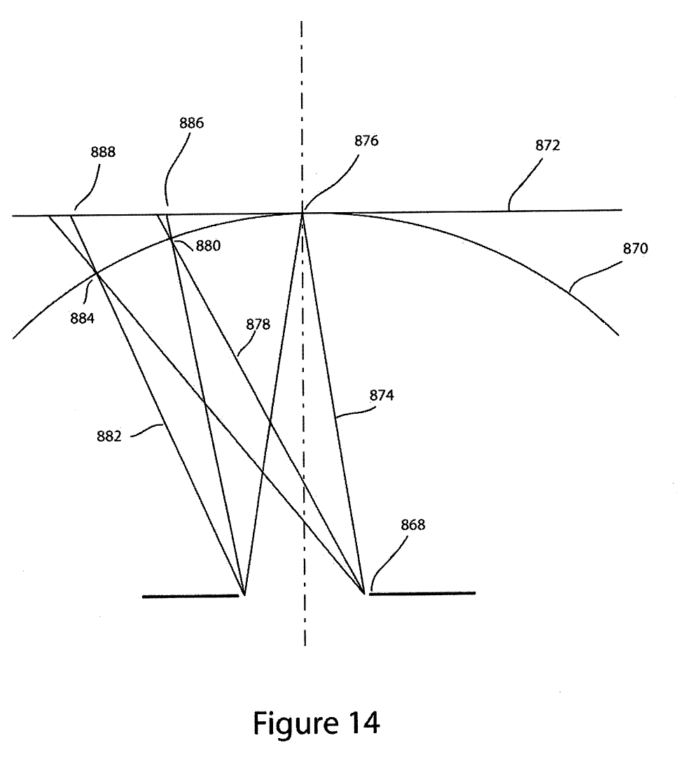

As a third example, field curvature may be introduced by the illumination system, resulting in the different irradiance levels across the grid of illuminated fields of view. In this case, more uniform distribution of energy may be achieved by using holographic elements to vary the amount of energy diffracted into specific locations in the grid. In the embodiment of FIG. 14 the amount of energy at specific locations in the object plane is related to angular distribution of energy by the hologram. Hence, by changing the efficiency of appropriate diffraction orders the irradiance pattern can be made more nearly uniform. Illumination light exiting the optical system aperture 868 forms image surface 870 that is curved and deviates from the object plane 872. While light 874 is focused on the object plane at its intersection 876 with the optical axis of the illumination system, at other field angles the light is focused on image surface 870, away from the object plane. For example, light 878 is focused at point 880, and light 882 is focused at point 884, rather than at the object plane. Because those focus points are away from the object plane, the energy at points 880 and 884 on surface 872 is spread over larger areas 886 and 888, respectively, resulting in lower, field-dependent irradiance. By making the holographic element so that it varies the amount of diffracted energy with field angle, the irradiance at the object plane can be made more uniform.

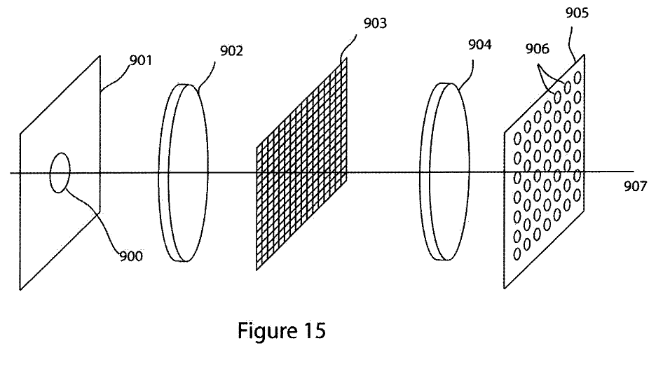

Another embodiment of the invention is shown in FIG. 15. In this case a two-dimensional diffraction grating 903 is used to create a multiplicity of fields of view in the image plane 906. The grating has two sets of perpendicular lines which create a rectangular grid of diffraction orders which obey the well known law of light diffraction. In this case the grating can be regarded as a thin holographic element. FIG. 15 shows a critical illumination system where the light source 900 is located in the front focal plane 902 of the lens 902. Diffraction grating 903, which is located in the back focal plane of lens 901 and in the front focal plane of lens 904, splits incoming light into a multitude of beams propagating at angles with respect to the optical axis 907. Lens 904 focuses light on to the object plane 905 located in its focal plane into an array of fields of view 905. Such an optical system is known in literature as a “4f filter,” but is typically used in area of optical computing and Fourier filtering. The illumination system of FIG. 15 provides telecentric Kohler illumination that, as mentioned above, has the advantage that the exit pupil is located at infinity, since the system pupil is located in the plane of grating 903.

The terms and expressions which have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims that follow.

1. In a multi-axis imaging system having a plurality of laterally-distributed imaging elements and an imaging object plane, the imaging elements having respective optical imaging axes that are spaced apart from one another, an illumination system, comprising:
a light source; and
an illumination subsystem having a diffractive optical element disposed between said light source and the imaging object plane for providing selective illumination of areas of an object placed at the imaging object plane within the fields of view of respective laterally-distributed imaging elements.

2. The illumination system of claim 1, wherein, in response to light from said light source, said diffractive element concentrates the light on areas within the fields of view of said respective laterally-distributed imaging elements.

3. The illumination system of claim 2, wherein the angular distributions of respective cones of light directed by said diffractive element toward said respective laterally-distributed imaging elements substantially match the respective numerical apertures of said imaging elements.

4. The illumination system of claim 3, wherein said light source is a substantially coherent light source.

5. The illumination system of claim 3, wherein said light source is an incoherent light source.

6. The illumination system of claim 3, wherein said light source is a quasi-monochromatic light source.

7. The illumination system of claim 3, wherein said diffractive element comprises a thick hologram.

8. The illumination system of claim 3, wherein said light source is a broad-band light source.

9. The illumination system of claim 3, wherein said illumination system further comprises a lens system for propagating light from the light source to said diffractive element.

10. The illumination system of claim 9, wherein said light source is an incoherent light source located at the front focal plane of said lens system.

11. The illumination system of claim 3, wherein said illumination subsytem is adapted to image the light source into the imaging object plane of one or more elements of the multi-axis imaging system so as to provide critical illumination.

12. The illumination system of claim 3, wherein said illumination subsystem is adapted to image the light source into the entrance pupil of one or more elements of the multi-axis imaging system so as to provide Kohler illumination.

13. The illumination system of claim 12, wherein said illumination system is telecentric.

14. The illumination system of claim 1, wherein said illumination subsystem comprises a plurality of diffractive elements.

15. The illumination system of claim 1, wherein said illumination subsystem comprises a combination of diffractive and refractive elements.

16. The illumination system of claim 15, wherein said illumination system comprises a combination of reflective, refractive and diffractive elements.

17. The illumination system of claim 1, further comprising a supplemental optical element disposed between said diffractive element and the object plane for providing focusing power.

18. The illumination system of claim 17, wherein said supplemental optical element comprises a refractive optical element.

19. The illumination system of claim 1, wherein said illumination subsystem includes one or more refractive elements and said diffractive element is adapted to compensate for one or more aberrations introduced by said one or more refractive elements.

20. The illumination system of claim 1, wherein said diffractive element is adapted to reduce chromatic dispersion therefrom.

21. The illumination system of claim 20, wherein said refractive elements are adapted to reduce dispersion of the illumination system.

22. A method for illuminating an object to be imaged, comprising diffracting illumination light so as to direct portions thereof into the fields of view of a respective plurality of imaging elements that have respective optical imaging axes spaced apart from one another and that define a common imaging plane.

23. The method of claim 22, further comprising illuminating with substantially coherent light.

24. The method of claim 22, further comprising illuminating with incoherent light.

25. The method of claim 22, further comprising illuminating with quasi-monochromatic light.

26. The method of claim 22, further comprising illuminating with broad-band light.

27. The method of claim 22, further comprising imaging illumination light from a light source into the object plane of one or more imaging elements.

28. The method of claim 22, further comprising imaging illumination light from a light source into the entrance pupil of one or more imaging elements.

29. The method of claim 22, further comprising refracting said portions of illumination light so as to focus said portions toward respective said imaging elements.

30. The method of claim 22, further comprising diffracting the illumination light so as to compensate for aberrations introduced by said refracting of said portions of illumination light.

31. The method of claim 22, further comprising diffracting said portions of illumination light so as to reduce chromatic dispersion therefrom.

32. The method of claim 22, wherein said trans-illuminating provides critical illumination of the object.

33. The method of claim 22, wherein said trans-illuminating provides Kohler illumination of the object.
